(19) United States
(12) Patent Application Publication
(10) Pub. No.: US 2013/0263139 A1
(43) Pub. Date: Oct. 3, 2013

(54) MANAGING EXECUTION OF APPLICATIONS IN A RUNTIME ENVIRONMENT

(71) Applicants: Lior Schejter, Givatayim (IL); Vishal Sikka, Los Altos Hills, CA (US); Matthias Anlauff, San Jose, CA (US); Jonathan Heller, Sunnyvale, CA (US)

(72) Inventors: Lior Schejter, Givatayim (IL); Vishal Sikka, Los Altos Hills, CA (US); Matthias Anlauff, San Jose, CA (US); Jonathan Heller, Sunnyvale, CA (US)

(21) Appl. No.: 13/432,785

(22) Filed: Mar. 28, 2012

(51) Int. Cl. G06F 9/46

(52) U.S. Cl. 718/102

(57) ABSTRACT

Systems, methods and techniques relating to managing execution of applications in a runtime environment are described. A described technique includes identifying logic for executing an application code, identifying a first portion of the application code associated with the identified logic and executed by a first runtime container, identifying a second portion of the application code associated with the identified logic, determining, based on a policy or a characteristic associated with the application code, a second runtime container to execute the second portion of the application code, and dispatching a request and the identified logic to the second runtime container for executing the second portion of the application code.

### TECHNICAL FIELD

The present disclosure relates to managing execution of applications in a runtime environment.

### BACKGROUND

Application software, also known as an “application” or an “app,” is designed to help software users perform a variety of tasks. Example application software may include enterprise software, accounting software, office suites, graphics-related software, and media players. In computer science and engineering, a runtime system (also known as a runtime environment or runtime) is designed to support the execution of application software. The runtime system may implement low-level and/or higher-level commands and support type checking, debugging, or even code generation and optimization, among others.

With the advent of computing platforms and computing power in general, applications have become more complex and may distribute across different runtime containers, machines and development paradigms, data warehouses, application servers, web clients, mobile clients, desktops, etc. Different layers of an application can take different forms of software artifacts and represent data in potentially different ways, resulting in possibly redundant data transformations made, even for relatively simple tasks. In addition, application logic is also distributed across different technologies and maintained in several different artifacts, making it challenging to understand, maintain and optimize. In many cases, when developing an application, the application developers have a clear notion of the different layers of applications in the frontend, logic tier and the database.

### SUMMARY

This disclosure provides various implementations of systems, computer program products, and methods for managing execution of applications in a runtime environment. Logic for executing an application code is identified by a first runtime container. The first runtime container also identifies a first portion of the application code associated with the identified logic and executed by the first runtime container, and a second portion of the application code associated with the identified logic. A second runtime container is then determined to execute the second portion of the application code, based on a policy or a characteristic associated with the application code, and a request and the identified logic are dispatched to the second runtime container for executing the second portion of the application code which in turn may continue to delegate the execution to additional runtime containers.

While generally described as a computer program that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic representation of an example system environment suitable for one or more implementations according to the present disclosure.

FIG. 2 is a schematic showing an example system for executing an application at runtime.

FIG. 3 is a flowchart showing an example process of executing an application at runtime.

Like reference symbols in the various drawings indicate like elements.

### DETAILED DESCRIPTION

This disclosure provides details and examples of managing execution of applications in a runtime environment. In some aspects, an application developer can describe an application (e.g., data structures and logic) using a relatively simple language, such as a set of domain specific language (DSL) or a general purpose programming language, and then deploy the associated software artifacts to a runtime container. The runtime container, while executing logic of the application by serving an execution request, can determine one or more runtime containers to execute the business logic to achieve certain performance criterion. The determination can be based on one or more characteristics and/or policies associated with the application. The one or more runtime containers may include different types of runtime containers. Different types of runtime containers can have different characteristics. Therefore, determination also includes determining the correct type of runtime container suitable for the execution of the business logic. By executing the business logic, an application flow is then optionally spread across the one or more runtime containers. The distribution may be performed automatically by the runtime container.

For example, a piece of business logic may have characteristics including (1) a validation logic that is to be performed, and (2) that the application execution includes processing large amounts of data. The piece of business logic can be described by a data manipulation DSL. When the business logic is triggered (e.g., in response to a request from a client machine), the runtime container can decide to execute the part of the validation logic on the client machine, and execute the rest of the batch process at a different node or system close (or closer) to a database (where the large amounts of data are stored), in order to avoid redundant data transformations and transmissions, while still allowing the validation logic to be effective on the client machine.

The decision on where to execute the logic can be dynamically determined. For example, the decision can occur at runtime based on several factors, including the runtime performance, regulatory (e.g., data protection laws), and business factors (e.g., capability and latency for a runtime container to execute the logic). Dynamically determining where to execute the logic at runtime can allow the application developers to define a set of policies that enable optimal practices for application execution in different environments for different types of applications. Furthermore, the defined policies may be reused and applied by different applications categorized similarly to an existing application using the defined policies.

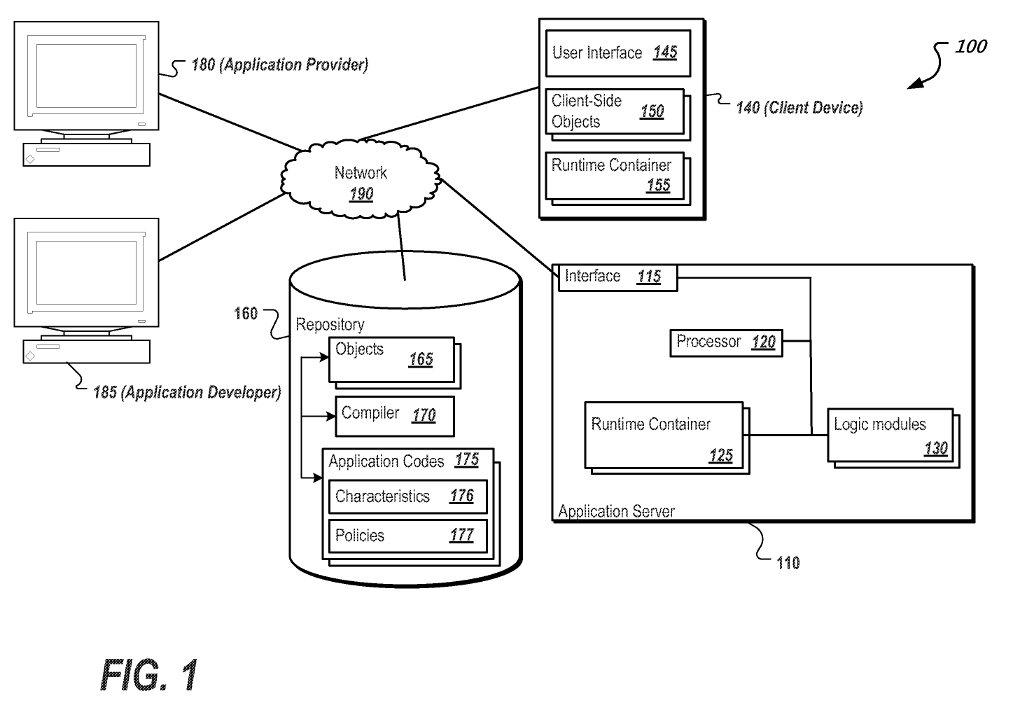

FIG. 1 is a schematic representation of an example system environment 100 suitable for one or more implementations according to the present disclosure. At a high level, the example system environment 100 includes, or is communicably coupled with, an application server 110, a client 140, a repository 160, an application provider 180, an application developer 185, and a network 190.

In the example system environment 100 illustrated in FIG. 1, the application server 110 can include a processor 120, an interface 115, one or more runtime containers 125 and one or more logic modules 130. In general, a server includes an electronic computing device operable to receive, transmit, process, store, or manage data and information associated with the system environment 100. The server may be responsible for communicating with one or more application providers 180, application developers 185 and/or clients 140 to perform one or more applications. Indeed, the server may be any computer or processing device such as, for example, a blade server, general-purpose personal computer (PC), Macintosh®, workstation, UNIX-based workstation, or any other suitable device. In other words, the present disclosure contemplates computers other than general purpose computers, as well as computers without conventional operating systems. Furthermore, the server may be adapted to execute any operating system, including Linux, UNIX, Windows®, Mac OS®, or another suitable operating system.

The application server 110 illustrated in FIG. 1 includes one or more runtime containers 125. A runtime container 125 can be a virtual machine, a database executing queries, or any runtime environment that is capable of executing program code of some form (e.g., queries, Input/output). In some implementations, the program code may be coded using a domain specific language (DSL).

A runtime container can be implemented on any computing device that is part of the system environment 100. For example, one or more runtime containers 125 are included in the application server 110, and one or more runtime containers 155 are included in a client device 140. It is to be understood that, although not shown in FIG. 1, a runtime container can also be included in at least one of the repository 160, application provider 180, and application developer 185. In some implementations, a runtime container can compile program code to a relevant technology/code native to the runtime container. In some instances, the runtime container can further compile framework code around the program code.

The application server 110 also includes one or more logic modules 130. A logic module 130 may be used for analyzing, processing, and/or dispatching at least a portion of logic associated with an application. Example logic can include business logic, computation logic, validation logic, execution logic, or client logic. In some implementations, the logic modules 130 can analyze application codes 175 at runtime for logic associated with an application. In some instances, the application codes 175 may be stored in a repository 160 communicably coupled to the application server 110 through a network 190. In some other instances, application codes may be stored locally at the application server 110.

The logic modules 130 can model objects 165 associated with the analyzed logic of the application. For example, when the logic is business logic, the objects modeled by the logic modules 130 can include accounts, loans, itineraries and inventories. The logic modules 130 may also prescribe how objects 165 interact with one another and enforce the routes and the methods by which objects are accessed and updated. The logic processed by the logic modules 130 can include rules that represent/define policies. For example, when the logic is business logic, example policies may include policies associated with channels, locations, logistics, prices, and products. The logic processed by the logic modules 130 can also include workflows that are the ordered tasks of passing documents or data from one participant (a person or a software system) to another.

The application server 110 further includes a processor 120. Although illustrated as a single processor 120 in FIG. 1, two or more processors may be used according to particular needs, desires, or particular embodiments of system environment 100. Each processor 120 may be a central processing unit (CPU), a blade, an application specific integrated circuit (ASIC), a field-programmable gate array (FPGA), or another suitable component. Generally, the processor 120 executes instructions and manipulates data to perform the operations of the application server 110 and, specifically, the application codes 175. Specifically, the processor 120 executes the functionality required to receive and respond to requests from the application provider 180, the client 140 and/or their respective applications, as well as the functionality required to perform the other operations of the applications. Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java™, Visual Basic, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate. In the illustrated system environment 100, processor 120 executes one or more application codes 175 of the application server 110.

Processors 120 suitable for the execution of a computer program include, by way of example, both general and special purpose microprocessors, and any one or more processors of any kind of digital computer. Generally, a processor 120 will receive instructions and data from a read-only memory, a random access memory, or both. The essential elements of a computer are a processor 120 for performing actions in accordance with instructions and one or more memory devices for storing instructions and data. Generally, a computer will also include, or be operatively coupled to receive, data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto optical disks; CD-ROM and DVD-ROM disks. The processor 120 and the database (or memory) can be supplemented by, or incorporated in, special purpose logic circuitry.

As shown in FIG. 1, the application server 110 also includes an interface 115. In general, the interface 115 is used for communicating with other systems in the illustrated example system environment 100 through the network 190. The interface 115 includes logic encoded in software and/or hardware in a suitable combination and operable to communicate with the network 190. More specifically, the interface 115 may comprise software supporting one or more communication protocols associated with communications such that the network 190 or interface's hardware is operable to communicate physical signals within and outside of the illustrated system environment 100. In some instances, the interface's hardware may include wireless transceivers and antennas (not shown). The wireless transceivers can include both the transmitter circuitry and the receiver circuitry. The wireless transceivers may be responsible for up-converting a baseband signal to a passband signal, or vice versa. The components of wireless transceivers may include a digital-to-analog converter/analog-to-digital converter, amplifier, frequency filter, and oscillator. The antenna is a transducer which can transmit and/or receive electromagnetic waves. The antenna can convert electromagnetic radiation into electric current, or vice versa. The antenna is generally responsible for the transmission and reception of radio waves, and can serve as the interface between the transceiver and the wireless channel.

A client device 140 can operate in the system environment 100. The client device can be any computing device that can execute at least a portion of the application code 175, such as a desktop computer, a laptop computer, a smartphone, and tablet computer. The client device 140 includes a user interface 145, client-side objects 150 and one or more runtime containers 155. The user interface 145 can be used to perform interactions between a client and other components of the system environment 100, including the application server 110 and the repository 160. The user interface 145 can also display information related to services provided by application provider 180 through the execution of application codes 175. For example, in a business system environment, the user interface can be used as the interface for browsing merchandise, purchasing, and shopping cart contents provided through business applications. The client-side objects 150 may be objects mapped to a code that is suitable for execution at the client device 140. The one or more runtime containers 155 can perform functionalities that are similar to that described with regard to the one or more runtime containers 125.

A repository 160 is included in the system environment 100. In general, the repository 160 may include any memory module or database and may take the form of volatile or non-volatile memory including, without limitation, magnetic media, optical media, random access memory (RAM), read-only memory (ROM), removable media, or any other suitable local or remote memory component. The repository 160 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the application server 110, the client 140, and/or the application codes 175. Additionally, the repository 160 may include any other appropriate data, such as virtual private network (VPN) applications, firmware logs and policies, firewall policies, a security or access log, print or other reporting files, as well as others.

The repository 160 includes one or more applications stored as application codes 175, a compiler 170 and one or more objects 165. In some implementations, the repository 160 can also include a runtime container and/or its own runtime environment (not shown). As such, at least a portion of the application code 175 can be executed locally at the repository. Although shown as stored in the repository 160, the application code 175 may be distributed among different system components as long as the application code 175 is accessible to the different system components. Furthermore, in some cases, data (not shown) associated with the execution of the application code 175 can be stored internally at the executing system(s), or externally to a central location, such as the repository 160. In some other cases, data can be distributed in memory (not shown) of the application server 110, client device 140, repository 160, or any other components included in or external to the system environment 100.

The application code 175 can correspond to one or more software applications. At a high level, each of the one or more applications can be any application, program, module, process, or other software that may execute, change, delete, generate, or otherwise manage information according to the present disclosure, particularly in response to and in connection with one or more requests received from the illustrated client 140 and/or the application server 110. In certain cases, only one application may be located at the repository. In others, a plurality of related and/or unrelated applications may be stored at a single repository, or located across a plurality of other system components, as well. In certain cases, system environment 100 may implement a composite application. For example, portions of the composite application may be implemented as Enterprise Java Beans® (EJBs), or design-time components may have the ability to generate runtime implementations into different platforms, such as J2EE® (Java™ 2 Platform, Enterprise Edition), ABAP (Advanced Business Application Programming) objects, or Microsoft's®.NET, among others. Additionally, the applications may represent web-based applications accessed and executed by the client 140 and/or the application server 110 via the network 190 (e.g., through the Internet). Further, while illustrated as internal to repository 160, one or more processes associated with a particular application may be stored, referenced, or executed remotely. For example, a portion of a particular application may be a web service associated with the application that is remotely called, while another portion of the application may be an interface object or agent bundled for processing at the client 140 and/or the application server 110. Moreover, any or all of the applications may be a child or sub-module of another software module or enterprise application (not illustrated) without departing from the scope of this disclosure. Still further, portions of the application may be executed by a user working directly at the repository 160, as well as remotely at client 140 and the application server 110.

The application codes 175 may explicitly or inherently include or be associated with one or more characteristics 176 and policies 177. When a runtime container is executing a portion of an application code 175 that corresponds to a task of an application, the characteristics 176 and policies 177 can be used by a runtime container to dynamically determine which system component to execute a parallel or subsequent task associated with the application.

Although three components (i.e., the application server 110, client device 140 and repository 160) are illustrated for dynamically executing at least a portion of the application code, in general, any number of computing devices that are associated with logic for executing the application code 175 may be used or incorporated into the described execution. When executing application code 175, logic associated with the application code 175 may be identified. In some implementations, the logic may also be associated with a control flow of executing the application. Based on the identified logic and/or the control flow, information associated with executing the application code 175 can be identified. The information can include system components associated with executing the application code 175 and the runtime container (e.g., runtime container 125 or 155) that starts the execution of the application code 175.

Before or at the time an application code 175 starts to be executed by a runtime container, the adjacent system components that may be available to execute the application code 175 can be available to and identified by the originating runtime container, based on the identified logic, or the control flow. Furthermore, at compile-time, the compiler 170 can generate data dependency information associated with the data flow of the application flow. For example, when the execution of an application code 175 involves objects 165 at the repository and objects 150 at the client device 140, a data dependency between the objects 165 and client-side objects 150 may be generated by the compiler 170.

Therefore, based on data dependency information, a runtime container can identify a portion of application code associated with the portion that is currently executed by the runtime container. Furthermore, the runtime container can identify one or more system components with which the identified portion of application code is associated. For example, when the execution of a portion of application code 175 involves the objects 165 associated with the repository 160, and the objects 165 have a data dependency with the client-side objects 150, a runtime container (not shown) may delegate the portion of application code 175 that involves the client-side objects to be executed at the client device 140. The delegation can involve dispatching the associated logic and sending a request to the client device 140. When the portion of the application code 175 identified based on data dependency is delegated to be executed by another system component, the system component can execute the portion of the application code 175 in parallel with the runtime container or in a subsequent time.

Data dependency may be one of the characteristics 176 for determining which system components to execute the application code 175. In some implementations, the characteristics 176 for the determination may be the characteristics of the application code 175 or the application itself. For example, some analytical applications may be characterized by reading a large amount of data, such that the application code may then be more efficiently executed at a database or repository that stores the data or components relatively close to the database or repository. For transactional applications, the application code may be more efficiently executed by client devices and/or servers involved in the transactions.

Example characteristics 176 can also include a capability characteristic associated with whether a system component is capable of executing a portion of the application code 175 to be delegated, and a latency characteristic associated with the latency for a system component to execute the portion of the application code 175 to be delegated. For example, a portion of the application code 175 may be executed by a runtime container that is capable of executing the portion, and/or has a relatively small latency of executing the portion. In some instances, one or more of these characteristics may be dynamically determined at runtime as the potential delegation nears a time to occur.

Besides characteristics 176, the determination of where to execute the application code 175 may also depend on one or more policies 177. Example policies for executing the application code 175 may include a security policy, an administrative policy, a service policy or a business policy. For example, the raw data of total quarterly sales of a merchant may be confidential based on a security policy, and is preferred to be stored and processed by a protected server. The statistics of the sales data may be considered less confidential based on the security policy, hence it can be stored and processed by a less protected and/or a public server. As for another example, a service policy may prevent application code from being processed by certain system components based on quality of service assurance, power conservation, or execution priority purposes. As another example, a business policy may prevent a single computing device from executing application code for two competing companies.

In some implementations, application code 175 may associate with more than one control flow. The execution of the application code 175 may start from the application server 110 or the client device 140 based on different control flows. In some implementations, a scheduler (not shown) may schedule the execution process of the application code 175 based on where application code and its associated operations/logic was deployed, as well as where resources are available in a system environment. In some instances, the compiler 170 can annotate the application code 175 to assist in a determination of where one or more portions of the application code 175 should or could be executed. For example, an application code can be referred to as independent of any technology or external functions. If the application code is calling a foreign function (e.g., executing a web service call), then at least one runtime container that executes the application code can have web service capabilities. A runtime container can determine whether it has the capability to execute certain portions of the application code by identifying the associated parties (e.g., objects) based on data dependency or compiled time annotation. When the runtime container has acquired the information about the parties involved in the execution, the runtime container can determine whether it can fulfill the request or delegate it. In some implementations, the annotation of the application code may be based on the type of runtime execution. For example, whether the runtime execution is highly data bound, computationally intensive, may be annotated as characteristics in order for the runtime container to determine where to execute the application code.

An application provider 180 may be included in the execution of application code 175 when foreign objects are involved in the execution. An application developer 185 may be responsible for the development of the application code 175. According to one or more implementations of the present disclosure, the application developer 185 can design the data structure and behavior of the application code 175 in a consistent and simple manner, while still allowing the execution of the application code 175 to be distributed and optimized on the available runtime container(s). In some implementations, the application developer 185 may describe the application code using a relatively simple language (e.g., a particular DSL), without worrying about characteristics of the layering and the physical boundaries of the system environment 100. Having the application defined in a relatively simple language, the underlying execution of the application code 175 at runtime can be decoupled from the distribution of the application code 175 by the application developer 185. This can give the application provider 180 the option to leverage best practices for executing application code categorized similarly more easily.

The application server 110, client device 140, repository 160, application provider 180 and application developer 185 are communicably coupled via a network 190. The network 190 may be all or a portion of an enterprise or secured network, while in another instance, at least a portion of the network 190 may represent a connection to the Internet. In some instances, a portion of the network 190 may be a virtual private network (VPN). Further, all or a portion of the network 190 can comprise either a wireline or wireless link. Example wireless links may include 802.11a/b/g/n, 802.20, WiMAX®, Bluetooth® and/or any other appropriate wireless link. In other words, the network 190 encompasses any internal or external network, networks, sub-network, or combination thereof operable to facilitate communications between various computing components inside and outside the illustrated environment. The network 190 may communicate, for example, Internet Protocol (IP) packets, Frame Relay frames, Asynchronous Transfer Mode (ATM) cells, voice, video, data, and other suitable information between network addresses. The network 190 may also include one or more local area networks (LANs), radio access networks (RANs), metropolitan area networks (MANs), wide area networks (WANs), all or a portion of the Internet, and/or any other communication system or systems at one or more locations.

While FIG. 1 is described as containing or being associated with a plurality of elements, not all elements illustrated within system environment 100 of FIG. 1 may be utilized in each alternative implementation of the present disclosure. Additionally, one or more of the elements described herein may be located external to system environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes, in addition to those purposes described herein.

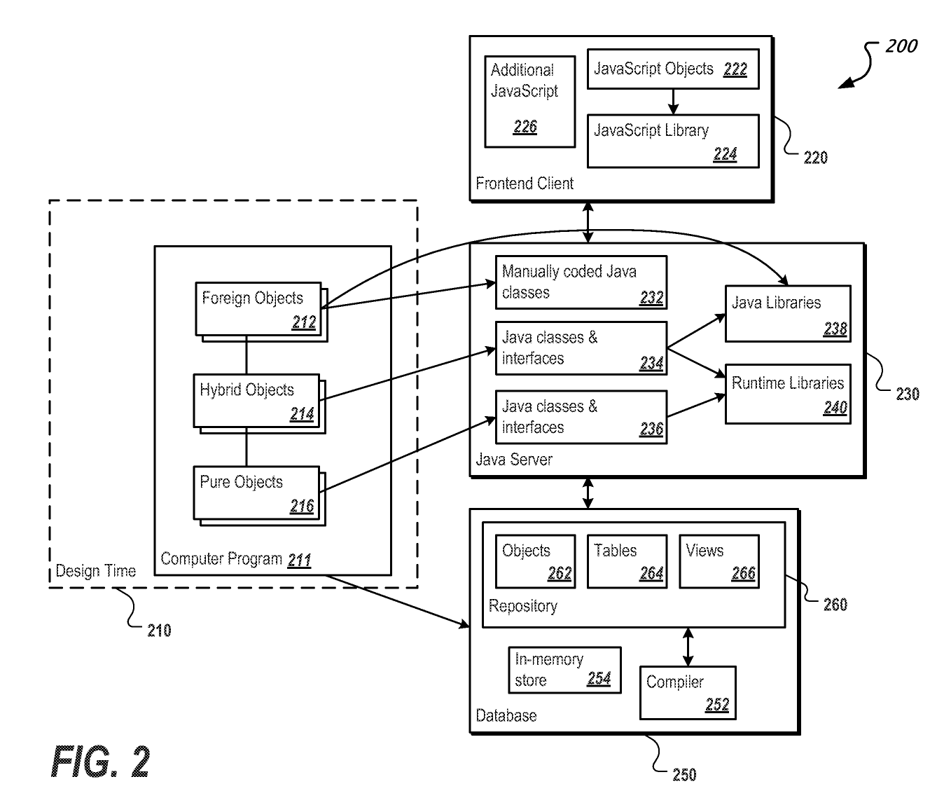

FIG. 2 is a schematic showing an example system 200 for executing an example application at runtime. The example system 200 comprises a design time 210 component, which is a computer program 211. The computer program 211 is an application code, and it may include specification and logic written in DSL. In some implementations, the computer program 211 may be written in arbitrary programming language, such as JavaScript®. The computer program 211 may include business logic that comprises different types of objects. In the illustrated example system 200, the computer program 211 includes foreign objects 212, hybrid objects 214, and pure objects 216.

The foreign objects may be objects specified using programming language other than the language used for coding the computer program 211. In the illustrated example system 200, the computer program 211 can be written in DSL. Therefore, the foreign objects may be specified using languages such as SQLScript, advanced business application programming (ABAP), or JavaScript®, among others. The hybrid objects may be objects that are partly specified in a DSL and partly using other programming languages, while the pure objects may be specified using DSL alone.

The objects included in the computer program 211 may be physically stored in a database 250. The database 250 may include a compiler 252, an in-memory store 254, and a repository 260. The repository 260 may further include objects 262 (such as the foreign objects 212, hybrid objects 214 and pure objects 216), tables 264 and views 266. The tables 264 and views 266 in the repository 260 can be descriptions of code that are used to create tables and views. The descriptions can then be used by the repository 260 to create the actual database tables and views when the computer program 211 is provisioned.

At compile time, the compiler 252 can perform the compilation the objects 262. The foreign objects 212 may be mapped to existing Java artifacts such as the manually coded Java classes 232 and Java libraries 238 stored in the Java server 230. The hybrid objects 214 may be mapped to Java™ classes and interfaces 234. Since the hybrid objects include application code written in both DSL and non-DSL languages, the Java™ classes and interferences 234 may reference to both Java™ libraries 238 and runtime libraries 240. The pure objects 216 may be compiled to Java™ classes and interfaces 236 and reference to runtime libraries 240.

A frontend client 220 may be a client device 140 as described with respect to FIG. 1. The frontend client 220 may include JavaScript® objects 222, a JavaScript® Library 224, and additional JavaScript® 226. Both the frontend client 220 and the Java™ Server 230 are communicably coupled to the database 250. In some implementations, the frontend client 220 may include a user interface or a browser. When the frontend client 220 initiates the execution of the computer program 211, a runtime container (not shown) at the frontend client 220 may determine whether the execution of the computer program 211 can be performed locally or delegate to other system component such as the Java server 230 or the repository 260.

As described with respect to FIG. 1, when the application code (i.e., the computer program 211) is executed in the runtime, a control flow may be identified by the runtime container, as well as data dependency characteristics, and/or policies of the application code. The characteristics may be used to determine where a portion of the computer program 211 can run and the frontend client 220 may not fetch all the data from the database, since some of the data may be delegated to be executed by other system components. The frontend client 220 can also identify what it can do with respect to the runtime execution and what other system components can do. Based on the characteristics and/or policies, the frontend client 220 can decide whether to execute the computer program 211 or delegate it to the Java™ Server 230 or the repository 260. In some implementations, where to execute an application code may also be determined prior to the runtime. For example, if the frontend client 220 is compatible with JavaScript® but not the particular DSL used, it may be predetermined to execute foreign objects 212 and a portion of the hybrid objects 214, and delegate the execution of the other portion of the hybrid objects 214 and the pure objects 216 to be executed by the Java™ server 230 by making a remote call in and request the Java™ server to continue the execution.

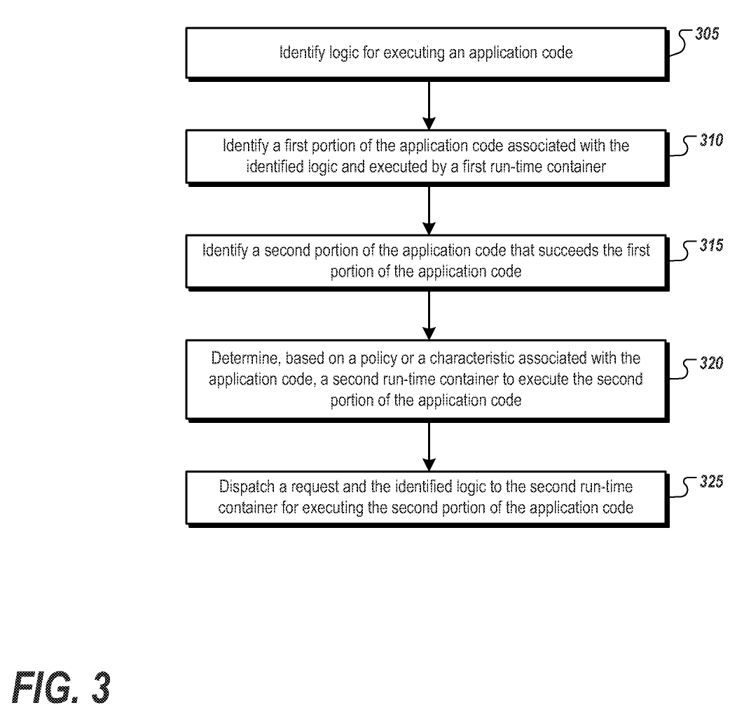

FIG. 3 is a flowchart showing an example process 300 of executing an application at runtime. At 305, logic for executing an application code is identified by a first runtime container. The logic may include at least one of business logic, computation logic, validation logic, execution logic, or client logic. At 310, a first portion of the application code associated with the identified logic is identified and executed by the first runtime container. In some instances, the first portion of the application code may correspond to the beginning portion of a logic flow associated with executing the application code. In such case, the runtime container is a runtime container included in a computing device that initiates and manages the execution of the application code. In some other instances, the first portion of the application code may correspond to any portion of the logic flow associated with executing the application code.

At 315, a second portion of the application code associated with the identified logic is identified. The second portion of the application code may be identified based on a data dependency of the first portion of the application code included in compile-time information generated by a compiler.

At 320, a second runtime container to execute the second portion of the application code is determined. In some implementations, the second runtime container and the first runtime container are the same. Each of the first runtime container and the second runtime container may be associated with at least one of a client device, an application server, a database, a web service, a computer, a user interface, or a virtual machine. The determination of the second runtime container can be based on a policy or a characteristic associated with the application code. Example policies may include a security policy, an administrative policy, a service policy, or a business policy. The characteristic can be a characteristic of the application code, and/or a characteristic of an application that corresponds to the application code. In some implementations, the characteristic is a capability characteristic, which characterizes capabilities for the first container and the second container to execute the second portion of the application code. In some implementations, the characteristic is a latency characteristic, which characterizes latencies for the first container and the second container to execute the second portion of the application code. In some instances, at least one characteristic may be determined dynamically based on a runtime evaluation of the system and its components. At 325, a request and the identified logic are dispatched to the second runtime container for executing the second portion of the application code. In some implementations, the dispatch of the request and the identified logic can be triggered by an invocation of an application programming interface (API) from an external entity outside of the first runtime container. Example invocation of an API can include a user clicks on a button or touches the touchscreen, an external application calls a web service, a web browser sends an HTTP Request, a sensor triggers a process (aka request) or, one runtime container calls another runtime container.

Although described in the example process 300 as a first runtime container and a second runtime container each executing at least a portion of the application code, the application code can include any number of portions executed by any number of runtime containers based on the various implementations described in the present disclosure. For example, the example process 300 can proceed to identify a third portion of the application code associated with the identified logic, determining, based on the policy or the characteristic associated with the application code, a third runtime container to execute the third portion of the application code, and dispatching a request and the identified logic to the third runtime container for executing the third portion of the application code.

While this specification contains many specific implementation details, these should not be construed as limitations on the scope of any that may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described components and systems can generally be integrated together in a single product or packaged into multiple products.

In the present disclosure, “each” refers to each of multiple items or operations in a group, and may include a subset of the items or operations in the group and/or all of the items or operations in the group. In the present disclosure, the term “based on” indicates that an item or operation is based at least in part on one or more other items or operations and may be based exclusively, partially, primarily, secondarily, directly, or indirectly on the one or more other items or operations.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A method comprising:
identifying logic for executing an application code;
identifying a first portion of the application code associated with the identified logic and executed by a first runtime container;
identifying a second portion of the application code associated with the identified logic;
determining, based on a policy or a characteristic associated with the application code, a second runtime container to execute the second portion of the application code; and
dispatching a request and the identified logic to the second runtime container for executing the second portion of the application code.

2. The method of claim 1, wherein the first runtime container and the second runtime container are the same.

3. The method of claim 1, wherein the second portion of the application code is identified based on a data dependency of the first portion of the application code included in compile-time information.

4. The method of claim 1, wherein the application code is stored in a repository that is communicably coupled to at least one of the first runtime container, or the second runtime container.

5. The method of claim 1, wherein each of the first runtime container and the second runtime container is associated with at least one of a client device, an application server, a database, a web service, a computer, a user interface, or a virtual machine.

6. The method of claim 1, wherein the logic includes at least one of a business logic, a computation logic, a validation logic, an execution logic, or a client logic.

7. The method of claim 1, wherein the policy includes at least one of a security policy, an administrative policy, a service policy, or a business policy.

8. The method of claim 1, wherein the characteristic is at least one of a characteristic of the application code, or a characteristic of an application that corresponds to the application code.

9. The method of claim 1, wherein the characteristic is a capability characteristic, and wherein the capability characteristic is associated with at least one of a capability for executing the second portion of the application code by the first runtime container, or a capability for executing the second portion of the application code by the second runtime container.

10. The method of claim 1, wherein the characteristic is a latency characteristic, and wherein the latency characteristic is associated with at least one of a time for executing the second portion of the application code by the first runtime container, or a time for executing the second portion of the application code by the second runtime container.

11. The method of claim 1, further comprising:
identifying a third portion of the application code associated with the identified logic;
determining, based on the policy or the characteristic associated with the application code, a third runtime container to execute the third portion of the application code; and
dispatching a request and the identified logic to the third runtime container for executing the third portion of the application code.

12. A computer program product comprising computer-readable instructions embodied on tangible, non-transient media, the computer program product operable when executed to perform operations including:
identifying logic for executing an application code;
identifying a first portion of the application code associated with the identified logic and executed by a first runtime container;
identifying a second portion of the application code associated with the identified logic;
determining, based on a policy or a characteristic associated with the application code, a second runtime container to execute the second portion of the application code; and
dispatching a request and the identified logic to the second runtime container for executing the second portion of the application code.

13. The computer program product of claim 12, wherein the first runtime container and the second runtime container are the same.

14. The computer program product of claim 12, wherein the second portion of the application code is identified based on a data dependency of the first portion of the application code included in compile-time information.

15. The computer program product of claim 12, wherein the application code is stored in a repository that is communicably coupled to at least one of the first runtime container, or the second runtime container.

16. The computer program product of claim 12, wherein each of the first runtime container and the second runtime container is associated with at least one of a client device, an application server, a database, a web service, a computer, a user interface, or a virtual machine.

17. The computer program product of claim 12, wherein the logic includes at least one of a business logic, a computation logic, a validation logic, an execution logic, or a client logic.

18. The computer program product of claim 12, wherein the policy includes at least one of a security policy, an administrative policy, a service policy, or a business policy.

19. The computer program product of claim 12, wherein the characteristic is at least one of a characteristic of the application code, or a characteristic of an application that corresponds to the application code.

20. The computer program product of claim 12, wherein the characteristic is a capability characteristic, and wherein the capability characteristic is associated with at least one of a capability for executing the second portion of the application code by the first runtime container, or a capability for executing the second portion of the application code by the second runtime container.

21. The computer program product of claim 12, wherein the characteristic is a latency characteristic, and wherein the latency characteristic is associated with at least one of a time for executing the second portion of the application code by the first runtime container, or a time for executing the second portion of the application code by the second runtime container.

22. The computer program product of claim 12, further comprising:
identifying a third portion of the application code associated with the identified logic;
determining, based on the policy or the characteristic associated with the application code, a third runtime container to execute the third portion of the application code; and
dispatching a request and the identified logic to the third runtime container for executing the third portion of the application code.

23. A system comprising:
a run-time container; and
a processor, operable to cause the run-time container to:
identify logic for executing an application code;
identify a first portion of the application code associated with the identified logic and executed by a first runtime container;
identify a second portion of the application code associated with the identified logic;
determine, based on a policy or a characteristic associated with the application code, a second runtime container to execute the second portion of the application code; and
dispatch a request and the identified logic to the second runtime container for executing the second portion of the application code.
